(19) United States
(12) Patent Application Publication
(10) Pub. No.: US 2017/0215579 A1
(43) Pub. Date: Aug. 3, 2017

(54) Shelving System

(71) Applicants: David James Cooper, Carlisle (AU); Ashley Welke, Bibra Lake (AU); Edward Joseph Khoury, Bateman (AU)

(72) Inventors: David James Cooper, Carlisle (AU); Ashley Welke, Bibra Lake (AU); Edward Joseph Khoury, Bateman (AU)

(21) Appl. No.: 15/500,454

(22) PCT Filed: Jul. 29, 2015
(86) PCT No.: PCT/AU2015/050428

§ 371 Date: Jan. 30, 2017

(30) Foreign Application Priority Data
Jul. 29, 2014 (AU) 2014902929

(51) Int. Cl. A47B 47/00; A47B 87/00; A61G 12/00; A47B 88/60; A47B 88/906; A47F 5/10; A47B 57/48; A47B 88/497

(52) U.S. Cl. CPC A47B 47/0083; A47B 57/48; A47B 87/008; A47B 88/497; A47B 88/60; A47B 88/906; A47F 5/108; A61G 12/001

(57) ABSTRACT

A shelving system (10) comprising a plurality of tubular posts (12) and a plurality of rail segments (72) securable parallel to the posts (14). Each of the rail segments (72) comprises an elongate member having a U-shaped cross section such that the rail segment includes a central wall (74) and first and second side walls (76, 77) such that the posts (12) are received between the first and second side walls (76, 77) and wherein the rail segments (72) include apertures (46) along the lengths thereof to receive tracks (48) for supporting drawers (51).

### FIELD OF THE INVENTION

The present invention relates to a shelving system.

### BACKGROUND TO THE INVENTION

A range of modular systems are available for creating shelving racks of various sizes. One known system, often used in the health industry, comprises tubular corner posts which are received in cylinders provided on the corners of wireframe shelving units. The shelving unit is assembled by sliding an appropriate number of shelves onto the corner posts. The posts are also provided with locking collars provided on the posts to be received into the lower ends of the cylinders on the shelves in order to secure the shelves in place. While such systems provide a relatively effective shelving system, the construction of the system makes reconfiguration of the shelving units by adding or removing shelves difficult.

Further, it is common for such shelving systems to require either shelves, drawers or a combination of the two. Existing shelving systems provide limited flexibility for both providing various configurations of these combinations and modifying the configuration as requirements change.

Another issue with such shelving systems, particularly when used in hospitals and similar environments, relates to the ability to clean the unit. Shelving systems commonly used include holes in the vertical posts to connect rails for drawers. Such systems allow the possibility of contaminants to enter the posts via these holes but provide no ability to clean these areas.

The present invention relates to a shelving system having features aimed at overcoming, at least in part, the abovementioned problems.

### SUMMARY OF THE INVENTION

According to one aspect of the present invention there is provided a shelving system comprising:

a plurality of tubular posts;
a plurality of rail segments securable parallel to the posts;
wherein each of the rail segments comprises an elongate member having a U-shaped cross section such that the rail segment includes a central wall and first and second side walls such that the posts are received between the first and second side walls and wherein the rail segments include apertures along the lengths thereof to receive tracks for supporting drawers.

Preferably a plurality of brace members are provided connecting adjacent posts and the rail segments are supported between adjacent brace members.

Preferably the first and second side walls include end portions thereon having arcuate surfaces to engage with outer surfaces of the post.

In a preferred embodiment, the apertures are provided in the first and second side walls of the rail segments.

Preferably the rail segments include engaging portions adjacent ends thereof provided to engage with brace members such that each of the rail segments is secured between an adjacent pair of brace members.

In a preferred embodiment, the engaging portions comprise notches provided adjacent opposed ends of the rail segments.

Preferably each of the rail segments includes a pair of notches in each end thereof.

In one embodiment, the brace members comprise elongate members extending between adjacent posts on a side of a frame structure formed by four posts, the brace members including brackets on ends thereof to receive the posts such that the brace members are supported from the post.

In one embodiment, a plurality of cross braces are provided to extend between the posts on a first side of the frame structure and the posts on a second side of the frame structure.

In one embodiment, one or more of the brace members comprises a side edge of a shelf supported within the frame structure.

In accordance with a second aspect of the present invention, there is provided a shelving system comprising:

a plurality of tubular posts;
a plurality of shelves;
a plurality of brackets provided on each of the shelves, each comprising a tubular member having a first portion secured to the shelves and a second portion securable to the first portion to define an opening between the first and the second portion; and
a plurality of collars receivable onto the corner posts;
wherein securing the second portion of each bracket to the first portion of the associated bracket such that a collar is located within the bracket secures the bracket relative to the post.

Preferably the first and second portions are each semi-cylindrical in shape such that when the second portion is secured to the first portion, the formed bracket is generally cylindrical in shape.

Preferably the posts each comprises a tubular member of circular cross section

Preferably each of the collars is formed of a first collar portion and a second collar portion wherein the first and second collar portions are each semi-cylindrical in shape and can be engaged with each other to form a cylindrical collar.

In one embodiment, the first and second collar portions each include a recess on a first longitudinal side thereof and a protrusion on a second longitudinal side thereof such that the protrusions of the first and second collar portions are receivable in the recesses of the second and first collar portions respectively to form the cylindrical collar.

Preferably each of the collars includes a circular rib on an inner surface thereof provided to engage into one of a plurality of circular grooves provided along the length of each of the posts when the collar is compressed by the bracket.

In a preferred embodiment, the collars are tapered to be greater in thickness adjacent a lower end thereof such that as each of the brackets is engaged with the collar by sliding downwardly, the collars are compressed such that the rib engages into an adjacent groove, thereby securing the collar relative to the post.

Preferably the first and second portions the brackets are engaged together by sliding.

In a preferred embodiment, the first portion of the bracket is provided with first engagement members along longitudinal edges thereof to engage with second engagement members provided along longitudinal edges of the second portion of the bracket.

In one embodiment, each of the first and second engagement members comprises an elongate protrusion having a transverse lip portion adjacent a distal edge thereof defining a channel such that the lip portion of the second engagement member engages into the channel of the first engagement member and vice versa.

In accordance with a third aspect of the present invention, there is provided a shelving system comprising a plurality of side members each having apertures for receiving lugs of a storage unit component, wherein each of the side members includes a longitudinal opening coverable by a removable cover strip to define a tubular channel into which the lugs are located when received in the apertures.

Preferably each of the side frames includes an L-shaped extrusion having a first planar side portion and a second planar side portion such that the longitudinal opening is defined between distal edges of the first and second planar side portions.

Preferably the apertures are provided along the length of the first planar side portion.

Preferably the cover strip includes a first side provided to engage with the distal edge of the first planar side portion and a second side provided to engage with the distal edge of the second planar side portion.

### BRIEF DESCRIPTION OF THE DRAWINGS

The invention will now be described, by way of example, with reference to the following drawings, in which:

FIG. 1 is an exploded view of a frame structure of a shelving system frame in accordance with the first and second aspects of the present invention;

FIG. 2a is a first perspective view of one of the rail segments of the shelving system of FIG. 1;

FIG. 2b is a second perspective view the rail segment;

FIG. 3a is an upper perspective view of the shelving system of FIG. 1 assembled including drawers;

FIG. 3b is a cross sectional view of a portion of the post of the shelving system of FIG. 3a adjacent the brace member;

FIG. 4 is a partially assembled view of a shelving system in accordance with the first and second aspects of the present invention including shelves;

FIG. 5 is an assembled view of the shelving system of FIG. 4;

FIG. 6 is a view of the shelving system of FIG. 5 including drawers;

FIG. 7a is a view of the shelving system of FIG. 6;

FIG. 7b is a cross sectional view of the shelving system of FIG. 7a through a first post adjacent a shelf;

FIG. 8a is a view of the shelving system of FIG. 6;

FIG. 8b is a cross sectional view of the shelving system of FIG. 8a through a second post adjacent the shelf;

FIG. 9 is an upper perspective view of a shelving system in accordance with the second aspect of the present invention;

FIG. 10a is an upper perspective view of the shelving system of FIG. 9 showing a shelf prior to engagement of one of the associated collars with a post;

FIG. 10bis a close up view of the collar of FIG. 10a;

FIG. 11a is an upper perspective view of the shelving system of FIG. 9 showing the shelf positioned above the collar engaged with the post;

FIG. 11b is a close up view of the collar of FIG. 11a;

FIG. 12a is an upper perspective view of the shelving system of FIG. 9 showing the shelf sliding into place such that the first portion of the brackets engages the collar;

FIG. 12b is a close up view of the bracket and collar of FIG. 12a;

FIG. 13a is an upper perspective view showing the first portion of the bracket engaged with the collar;

FIG. 13b is a close up view of the bracket and collar of FIG. 13a;

FIG. 14a is an upper perspective view of the shelving system of FIG. 9 showing the second portion of the bracket located adjacent the collar;

FIG. 14b is a close up view of the bracket and collar of FIG. 14a;

FIG. 15a is an upper perspective view of the shelving system of FIG. 9 showing the second portion of the bracket partially engaged with the first portion of the bracket;

FIG. 15b is a close up view of the bracket and collar of FIG. 15a;

FIG. 16a is an upper perspective view of the shelving system of FIG. 9 showing the second portion of the bracket fully engaged with the first portion of the bracket;

FIG. 16b is a close up view of the bracket of FIG. 16a;

FIG. 17a is an upper perspective view of a shelving system in accordance with the third aspect of the present invention;

FIG. 17b is a cross sectional view of the shelving system of FIG. 17a through one of the posts;

FIG. 18 is an upper perspective view of the shelving system of FIG. 17 showing the cover strips removed;

FIG. 19 is an exploded view of the shelving system of FIG. 17 excluding drawers;

FIG. 20a is an upper perspective view of a second embodiment of a shelving system in accordance with the third aspect of the present invention;

FIG. 20b is a cross sectional view of the shelving system of FIG. 20a through one of the posts;

FIG. 21 is an upper perspective view of the shelving system of FIG. 20 showing the cover strips removed;

FIG. 22a is an upper perspective view of a third embodiment of a shelving system in accordance with the third aspect of the present invention;

FIG. 22b is a cross sectional view of the shelving system of FIG. 22a through one of the posts.

### DETAILED DESCRIPTION OF PREFERRED EMBODIMENTS

Referring to the Figures, there is shown a shelving system 10 comprising a plurality of posts 12 provided to form a frame structure for receiving shelves 14 and/or drawers 51. The posts 12 may be provided with wheels 13 at lower ends thereof to provide mobility to the shelving system 10.

The posts 12 are provided to be secured to the drawers 51 and the shelves 14 around the periphery of the drawers 51 and shelves 14 to support the drawers 51 and the shelves 14 in a horizontal position.

In the embodiments shown, the drawers 51 and the shelves 14 are each rectangular and four posts 12 are provided to form the frame structure. The posts 12 are to be oriented vertically and secured adjacent the corners of each of the drawers 51 and the shelves 14 such that the drawers 51 and the shelves 14 extend horizontally across between the posts 12. The drawers 51 and the shelves 14 are securable to the posts 12 at a plurality of positions along the lengths thereof such that the number of drawers 51 and shelves 14 in the shelving system 10 and the distances between each of the drawers 51 and shelves 14 may be varied as required.

Each of the posts 12 comprises a tubular member of constant transverse cross section. In the embodiment shown, each of the posts 12 has a circular cross section.

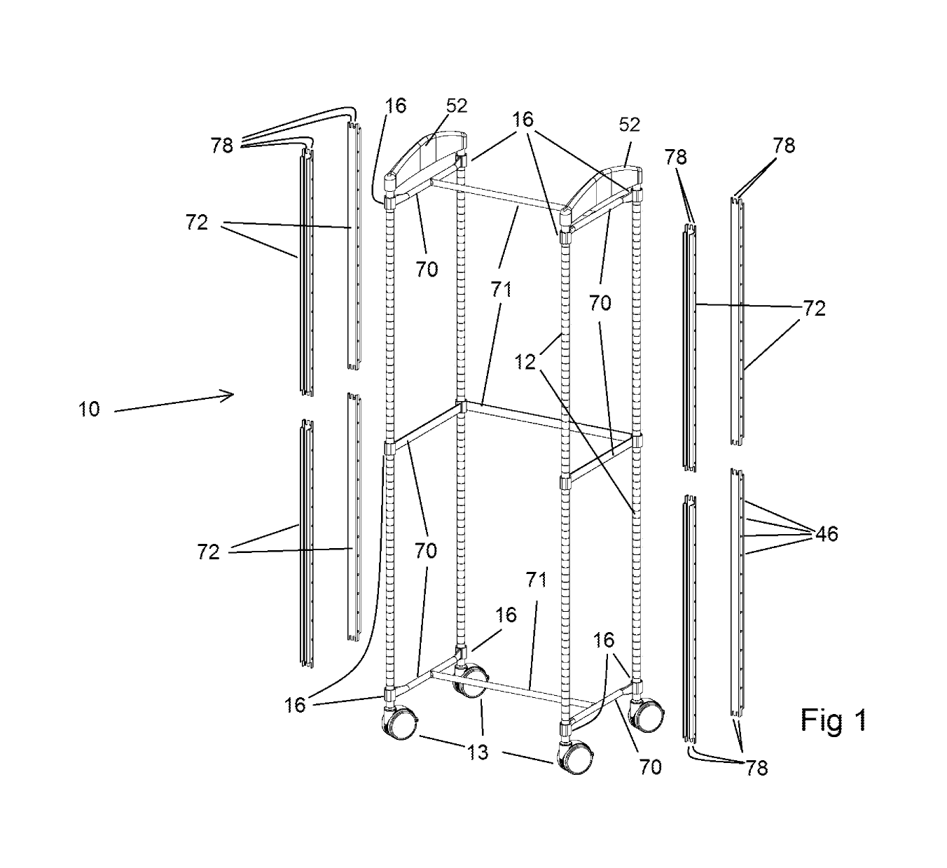

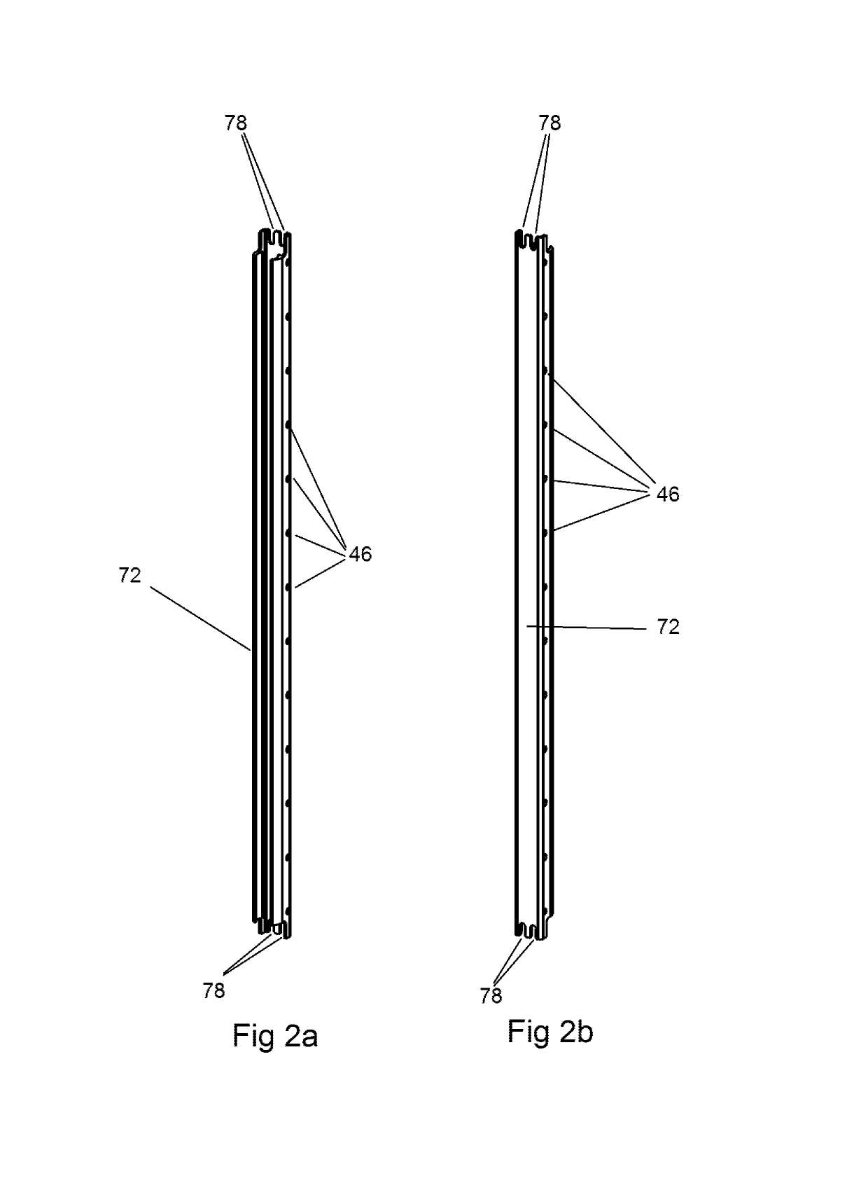

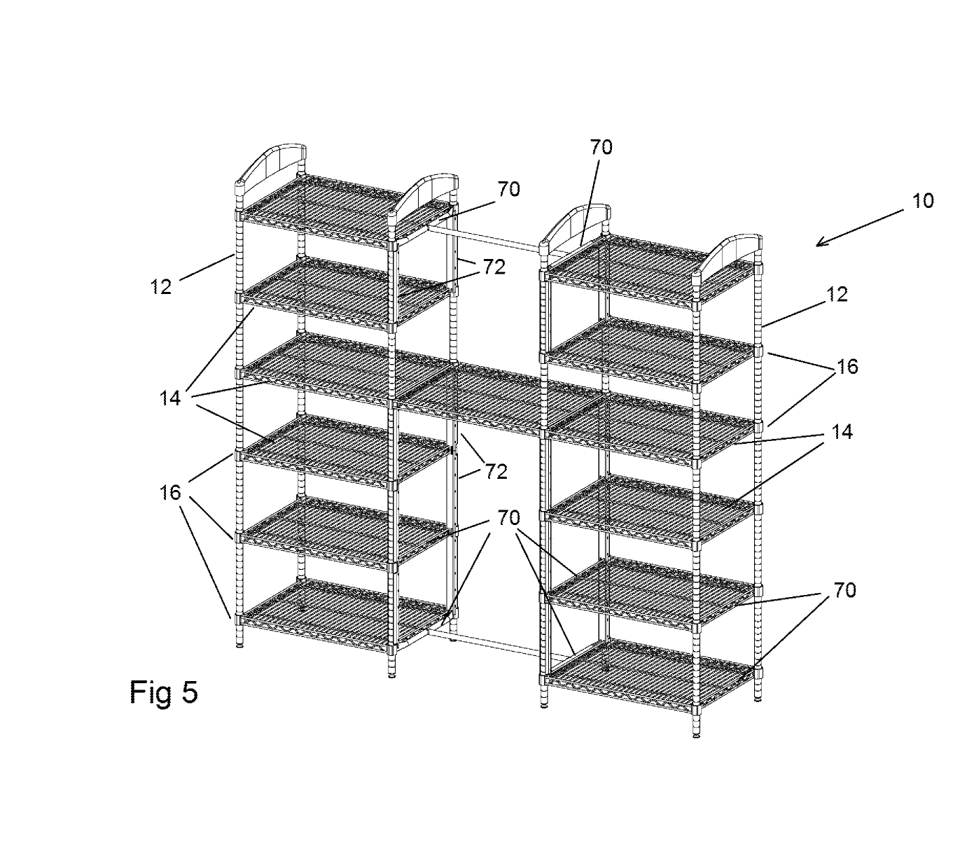

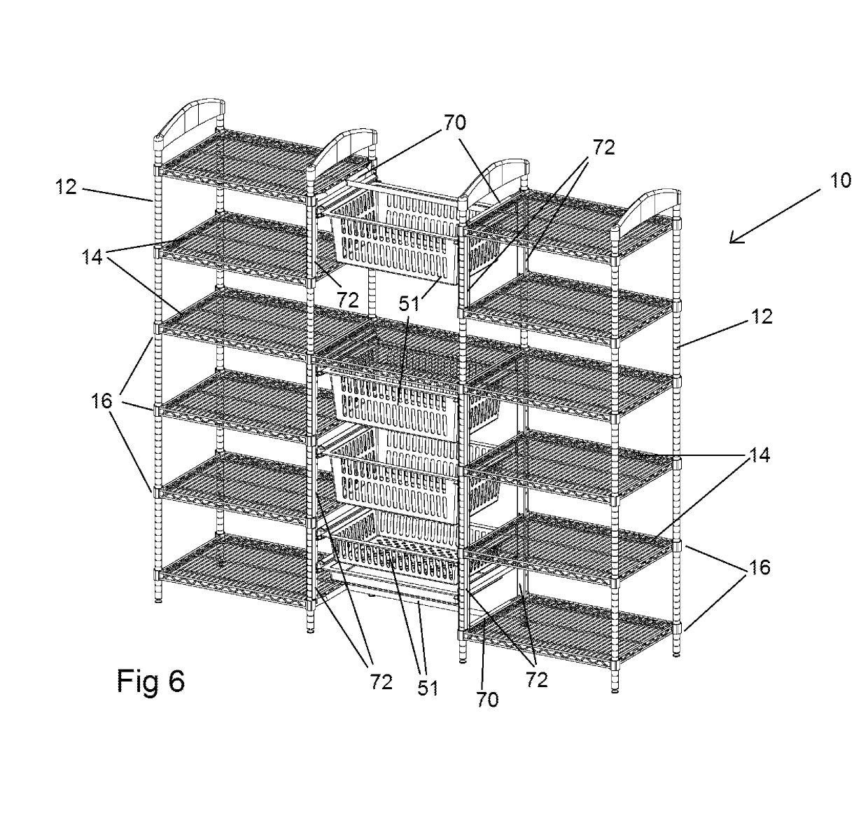

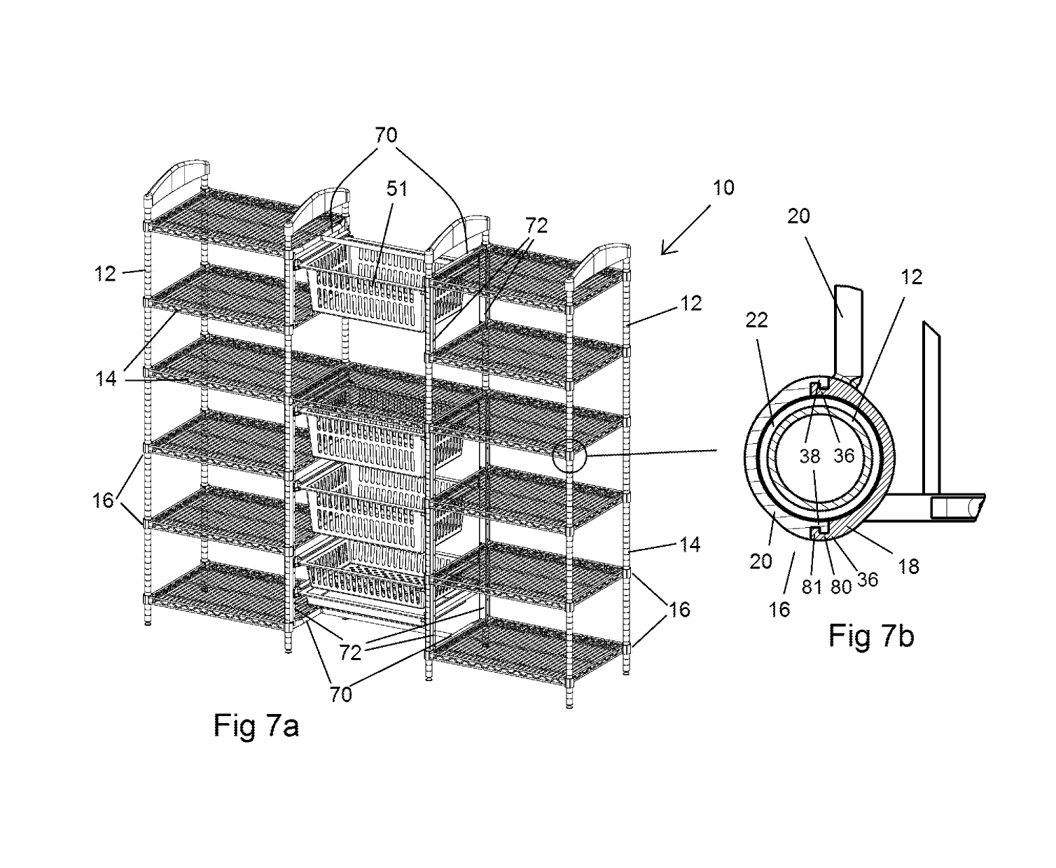

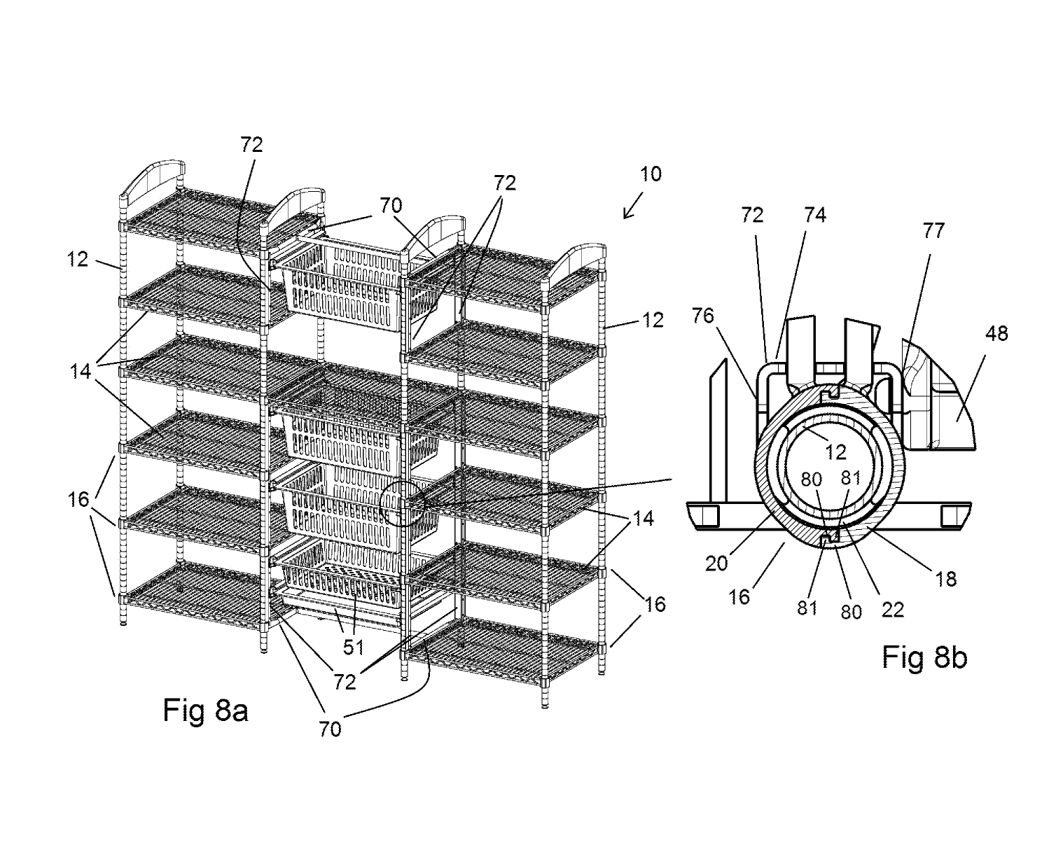

FIGS. 1 to 8 show a first embodiment of a shelving system 10 in accordance with the first and second aspects of the present invention. The shelving system 10 of FIGS. 1 to 8 is provided to support one or more drawers 51 but may also support one or more shelves 14.

The shelving system 10 comprises posts 12 secured together by brace members 70. The brace members 70 comprise elongate members extending between adjacent posts 12 in order to hold the posts in the correct configuration for receiving shelves 14. Each of the brace members 70 extends between a pair of posts 12 on a side of the frame structure. A plurality of cross braces 71 are provided to extend between the posts 12 on a first side of the frame structure and the posts 12 on a second side of the frame structure. In the embodiment shown, upper and lower brace members 70 are provided adjacent upper and lower ends of the frame structure and an intermediate brace member 70 is provided at a location generally between the upper and lower ends. Cross braces 71 are provided extending between midpoints of the upper and lower brace members 70 and also between rear ends of the intermediate brace members 70. It will be appreciated that any number of brace members 70 and cross braces 71 may be provided to ensure the frame structure is suitably stable.

Top supports 52 may also be provided extending between upper ends of the posts 14 on each side of the frame structure for further stability.

The brace members 70 include brackets 16 on ends thereof. The brackets 16 are provided to receive the posts 12 such that the brace members 70 are supported from the post 12. The construction and operation of the brackets 16 will be described in detail below.

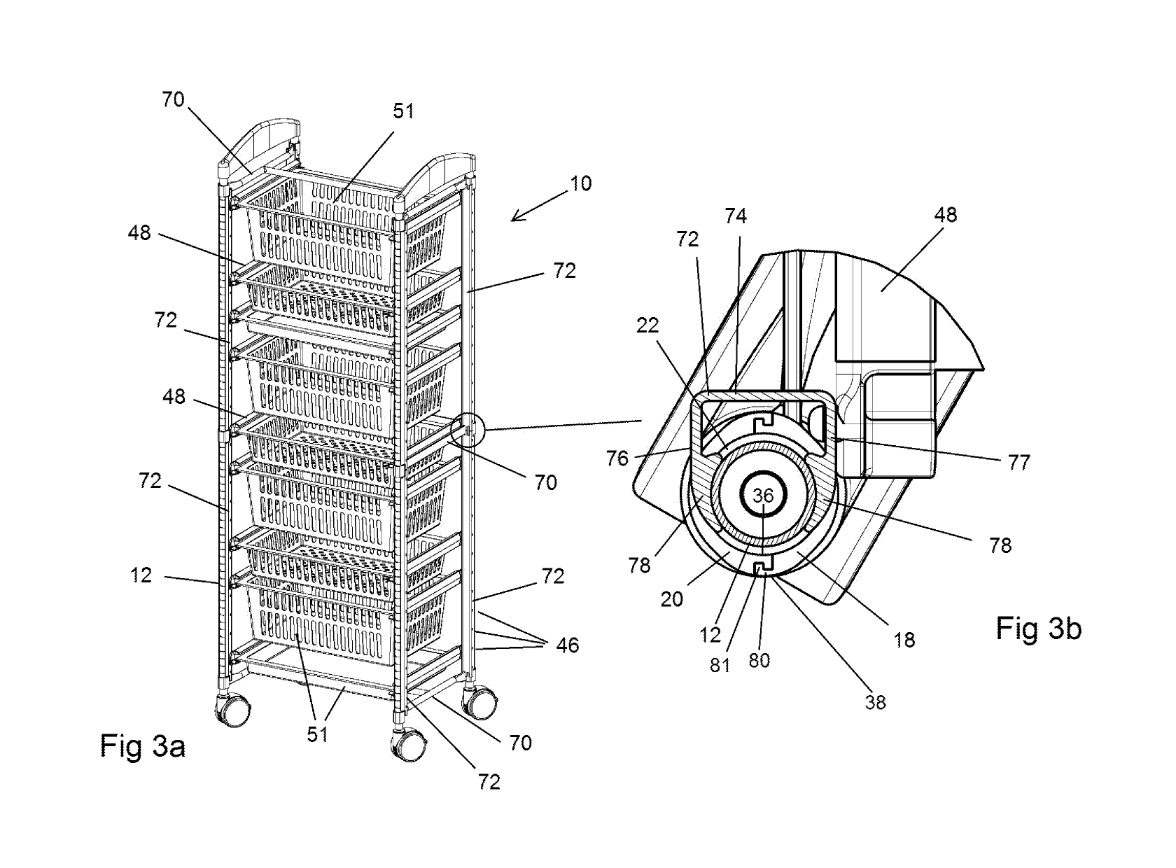

The shelving system 10 is provided also with rail segments 72 securable adjacent and parallel to the posts 12 in order to connect tracks 48 for securing drawers 51 Each of the rail segments 72 comprises an elongate member having a generally U-shaped transverse cross section. The rail segments 72 therefore comprise a central wall 74 and first and second side walls 76 and 77. As can be seen in FIG. 3b, the rail segments 72 are provided to be located such that the post 12 is receivable between the outer ends of the first and second side walls 76 and 77.

The first and second side walls 76 and 77 include arcuate end portions 78 thereon. The arcuate end portions 78 of each of the side walls 76 and 77 includes an arcuate surface on a side thereof adjacent the other of the side walls 76 and 77. The curvature of the arcuate surfaces is the same as the outer surface of the post 12 such that the post 12 can be received between the adjacent arcuate surfaces by sliding the post 12 between the first and second side walls 76 and 77. The first and second side walls 76 and 77 are flexed apart as the post is received in the rail segment 72.

Each of the rail segments 72 includes also engaging portions adjacent ends thereof. The engaging portions are provided to engage with brace members 70 such that each of the rail segments 72 is secured between an adjacent pair of brace members 70. The engaging portions comprise notches 78 provided adjacent opposed ends of the rail segment 72. Each of the rail segments 72 includes a pair of notches 78 in each end thereof.

The rail segments 72 also include apertures 46 along the lengths of the first and second side walls 76 and 77. The apertures 46 are provided for receiving tracks 48. The tracks 48 are provided to extend between a pair of posts 12 on one of the sides of the frame structure. Each of the tracks 48 is provided with lugs 50 on opposite ends thereof which can be received into selected apertures 46 such that the tracks 48 are supported horizontally between rail segments 72 on adjacent posts 12. The tracks 48 are provided to receive edges of sliding drawers 51. The tracks 48 may be placed in appropriate apertures 46 to accommodate drawers 51 of various sizes.

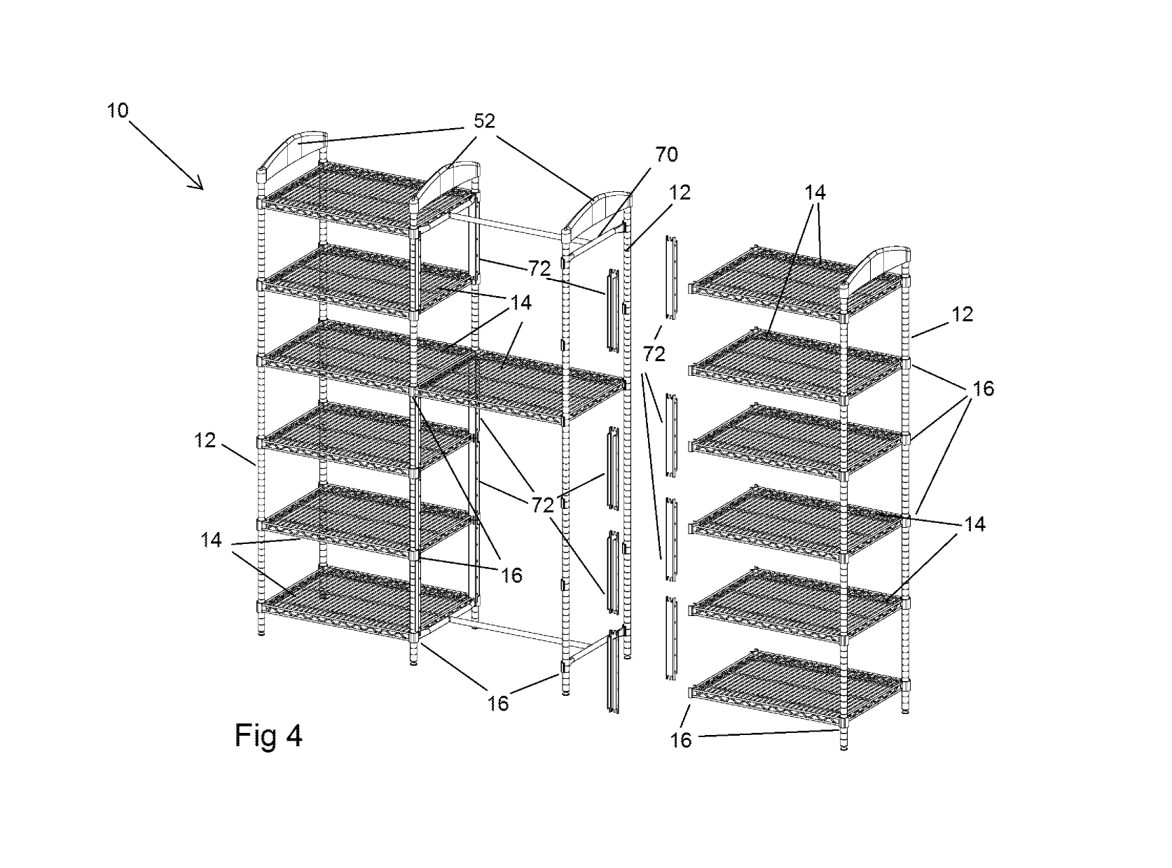

As can be seen in the Figures, the shelving system 10 may be used to create a unit having simply drawers 51 (as shown in FIG. 3), or may be used to create a system utilising both shelves 14 and drawers 51, as can be seen in FIGS. 4 to 8. In the case of shelves 14, the shelves 14 comprise rectangular shelves having front and rear edges and first and second side edges. The side edges of the shelves 14 therefore extend between adjacent posts 12 on the sides of the frame structure. As can be seen in the Figures, the notches 78 in the rail segments 72 can engage with the side edges of the shelves 14. As the shelves 14 extend between the posts 14 and therefore support the frame structure, separate brace members 70 and cross members 71 may not be required. The side edges of the shelves 14 therefore comprise the brace members 70 and the front and rear edges comprise the cross braces 71.

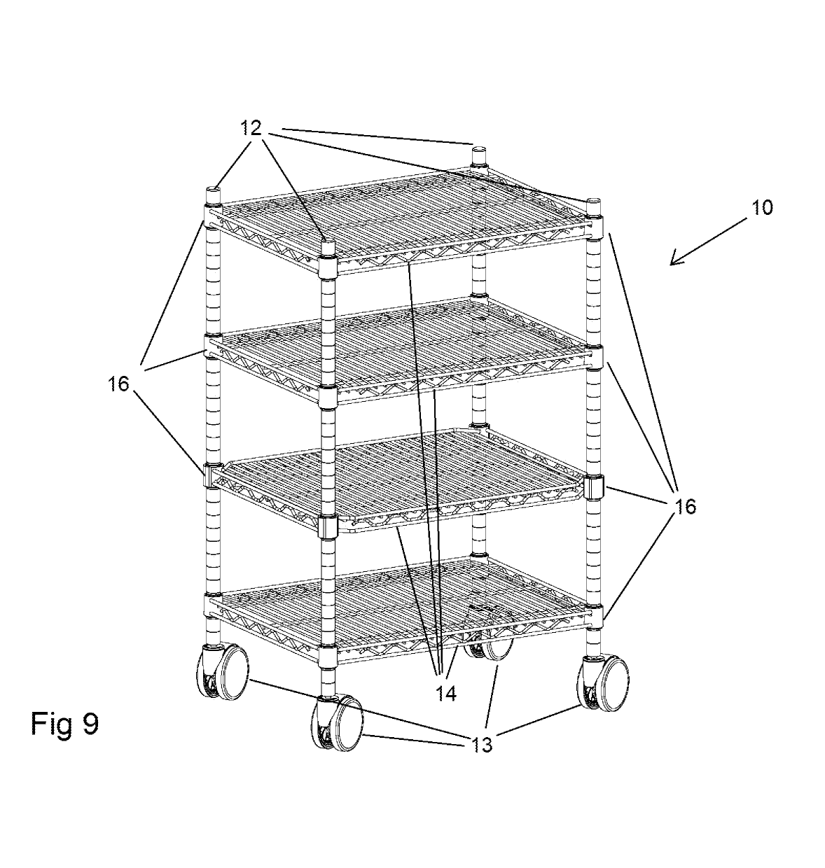

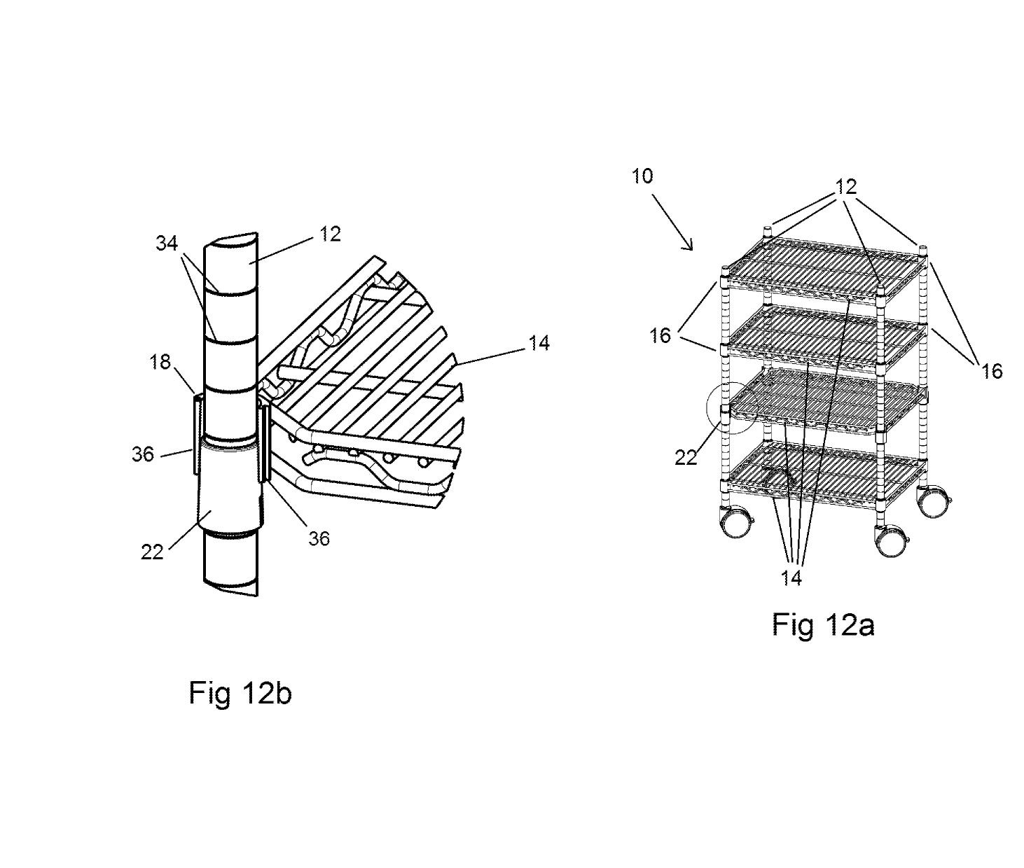

The connection of the brackets 16 relative to the posts 12 can be seen in more detail in FIGS. 9 to 16. In the embodiment of FIGS. 9 to 16, the brackets 16 are provided on the corners of the shelves 14, however brackets 16 of a similar construction and operation are also used on ends of the brace members 70 of FIGS. 1 to 8.

Each of the shelves 14 includes a plurality of brackets 16 provided to engage with the posts 12 to support the shelf 14 from the posts 12. Each of the brackets 16 comprises a first portion 18 fixed to the shelf 14 and a second portion 20 which is connectable to the first portion 18. The first and second portions 18 and 20 are each semi-cylindrical in shape such that when the second portion 20 is secured to the first portion 18, the formed bracket 16 is generally cylindrical in shape.

The shelving system 10 is also provided with a plurality of collars 22. The collars 22 are tubular in shape and are dimensioned such that the posts 12 can be received within the collars 22. The collars 22 can be received within the opening defined by the cylindrical bracket 16.

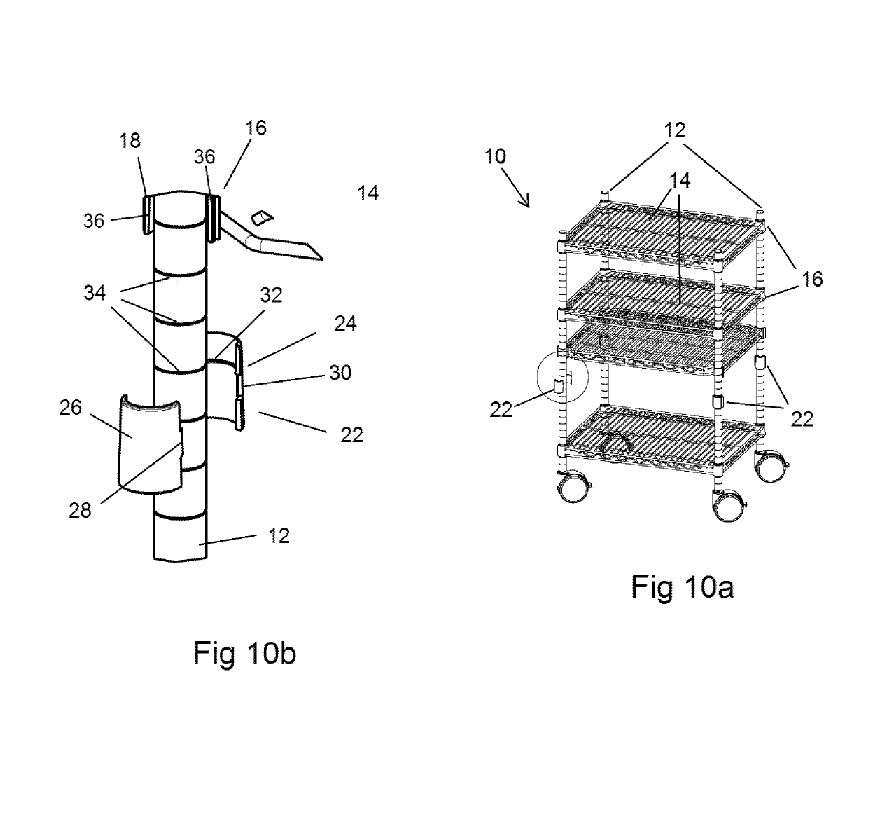

Each of the collars 22 is formed of a first collar portion 24 and a second collar portion 26. The first and second collar portions 24 and 26 are each generally semi-cylindrical in shape (as best seen in FIG. 10b) and can be engaged with each other to form the cylindrical collar 22. In the embodiment shown, the first and second collar portions 24 and 26 each include a recess 28 on a first longitudinal side thereof and a protrusion 30 on a second longitudinal side thereof. The protrusions 30 of the first and second collar portions 24 and 26 are receivable in the recesses 28 of the second and first collar portions 26 and 24 respectively to form the cylindrical collar 22.

Each of the collars 22 includes a circular rib 32 on an inner surface thereof. The rib 32 is provided to engage into one of a plurality of circular grooves 34 provided along the length of each of the posts 12. The collars 22 are tapered such that the collars 22 are greater in thickness adjacent a lower end thereof. As each of the brackets 16 is engaged with a corresponding collar 22 by sliding downwardly, the collars 22 are compressed slightly such that the rib 32 engages into an adjacent groove 34, thereby securing the collar 22 relative to the post 12. It is expected that the collars 22 may be constructed of a more flexible material, such as a plastics based material, while the brackets 16 on the shelves 14 would be metallic.

The first and second portions 18 and 20 of the brackets 16 are engaged together by sliding. The first portion 18 of the bracket 16 is provided with first engagement members 36 along longitudinal edges thereof. The first engagement members 36 are provide to engage with second engagement members 38 provided along longitudinal edges of the second portion 20 of the bracket.

In the embodiment shown, each of the first and second engagement members 36 and 38 comprises an elongate protrusion 80 having a transverse lip portion 81 adjacent a distal edge thereof. The elongate protrusion 80 is thinner than the first and second portions 18 and 20 of the bracket 16 adjacent the edges such that the transverse lip portion 81 defines a channel. The lip portion 81 of the second engagement member 38 engages into the channel of the first engagement member 36 and vice versa such that the first and second portions 18 and 20 of the bracket 16 are connectable by sliding. The second portion 20 may therefore be positioned above the first portion 18 and slid downwardly thereby securing the first and second portions 18 and 20 together.

A shelf 14 of the shelving system 10 may therefore be secured in place between the posts 12 as shown in the sequence from FIGS. 10 to FIG. 16. Collars 22 are located on the posts 12 at the desired location by connecting together the first and second collar portions 24 and 26 about the posts 12 as shown in FIG. 10. The shelf 14 may be positioned between the posts 12 above the collars 22 by inserting through the posts 12 at an angle.

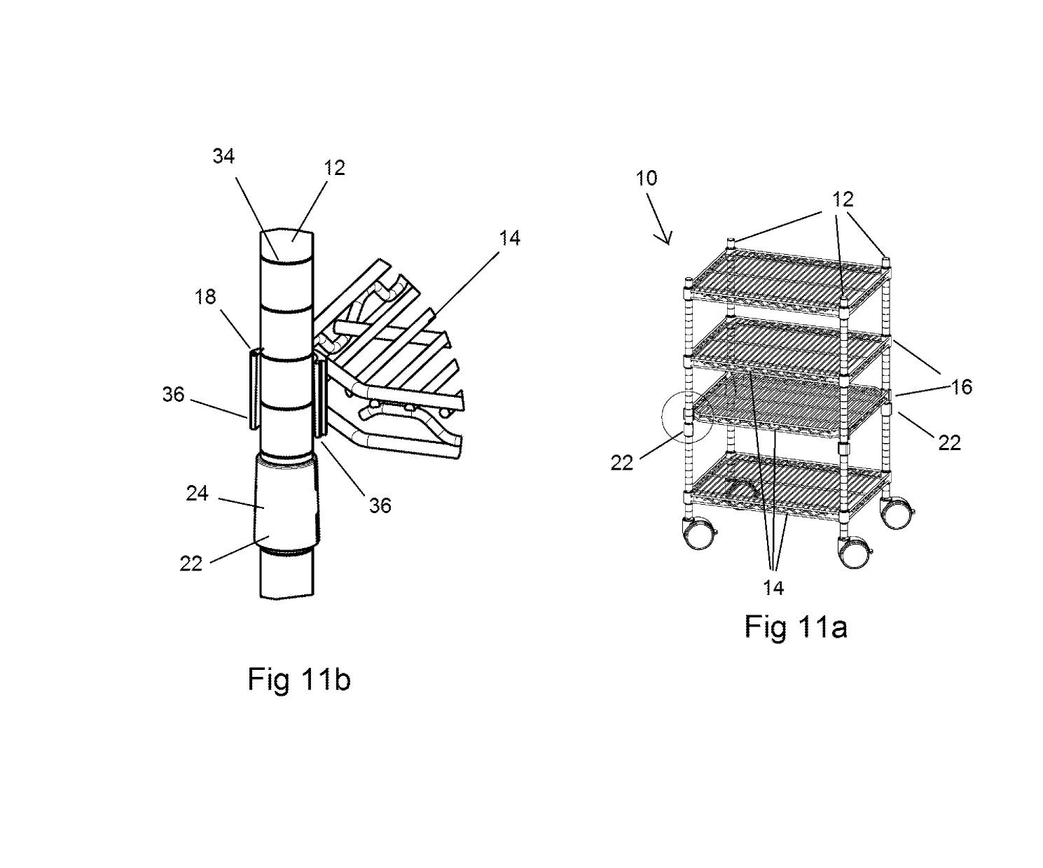

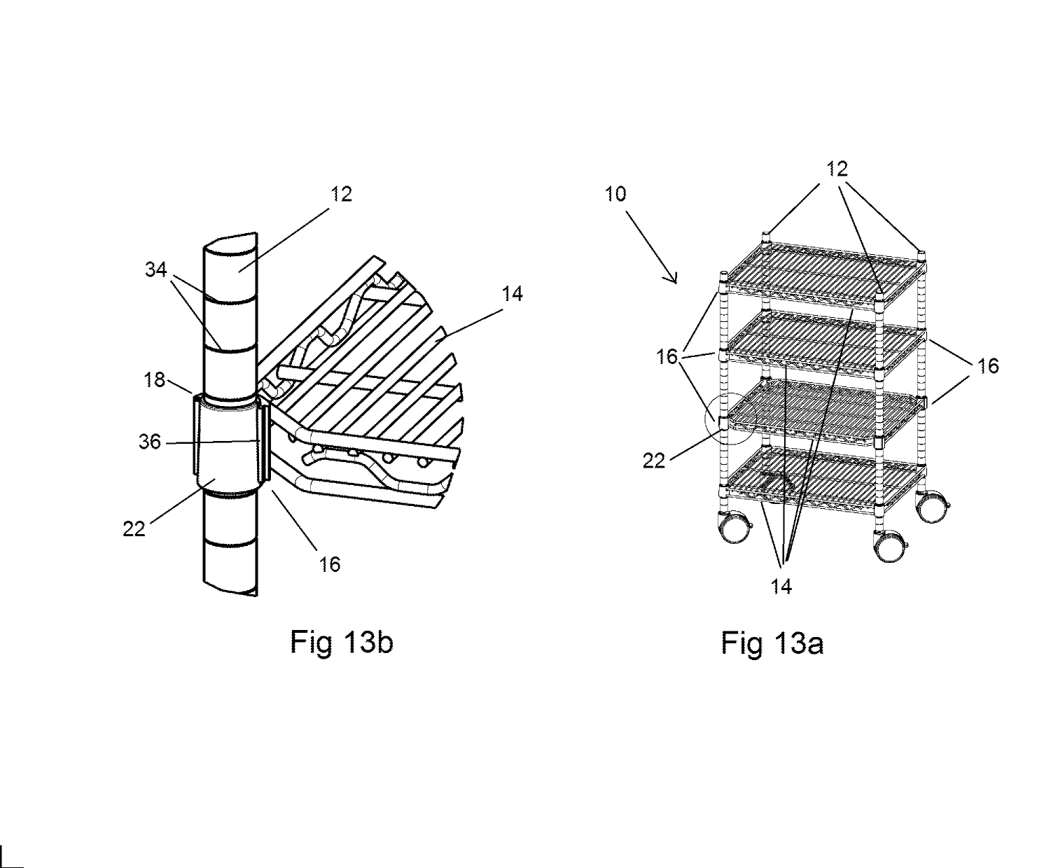

The shelf 14 is then moved downwardly as shown in FIGS. 11 to 13 until the first portion 18 of the bracket 16 is positioned alongside the collar 22 (as can be seen in FIG. 13).

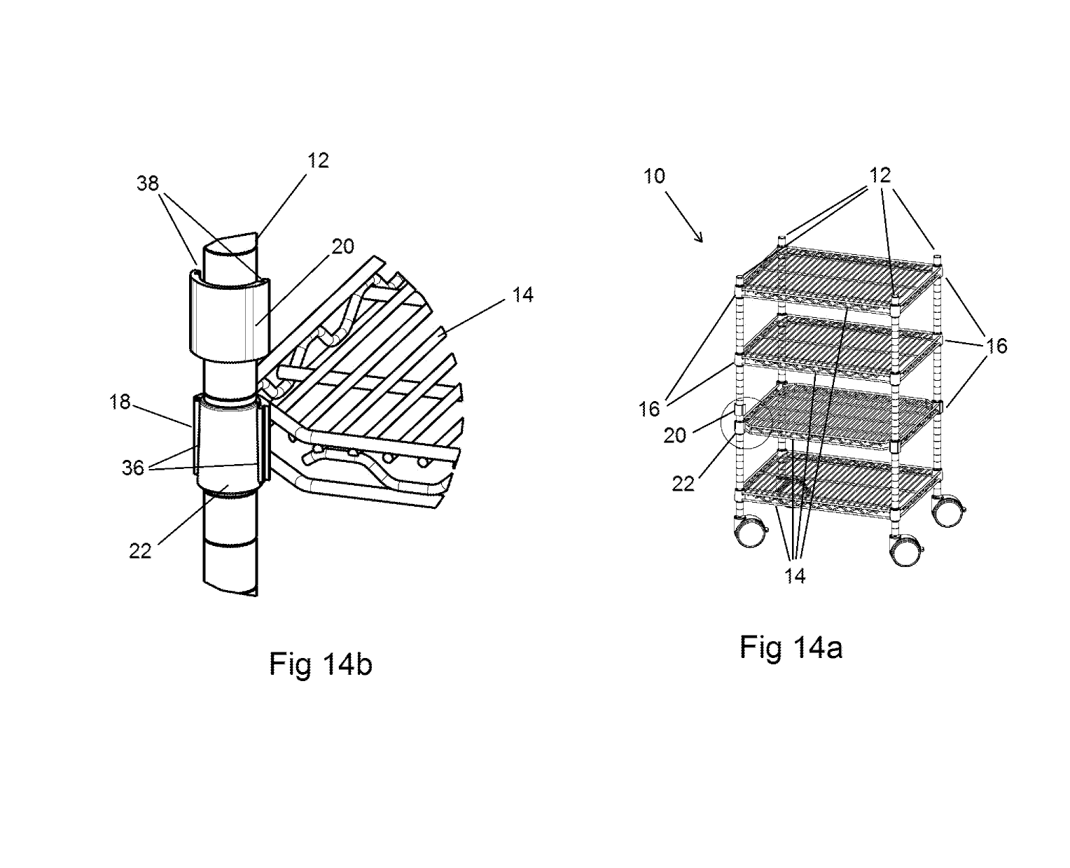

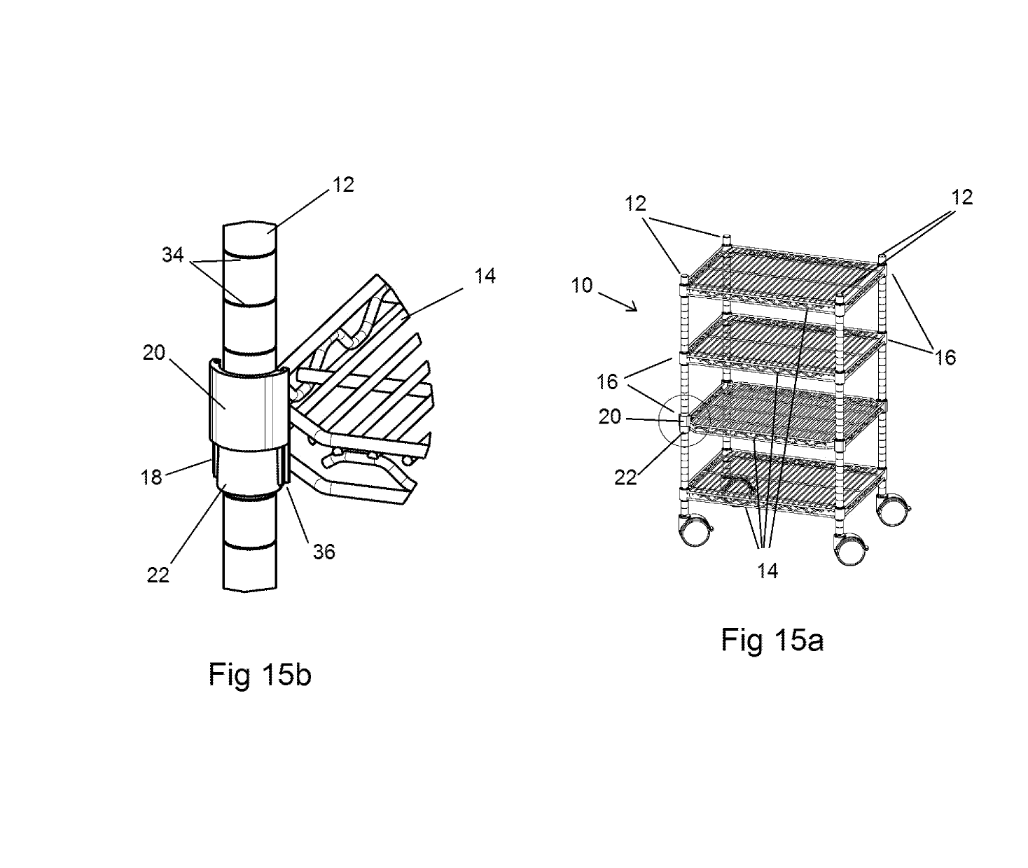

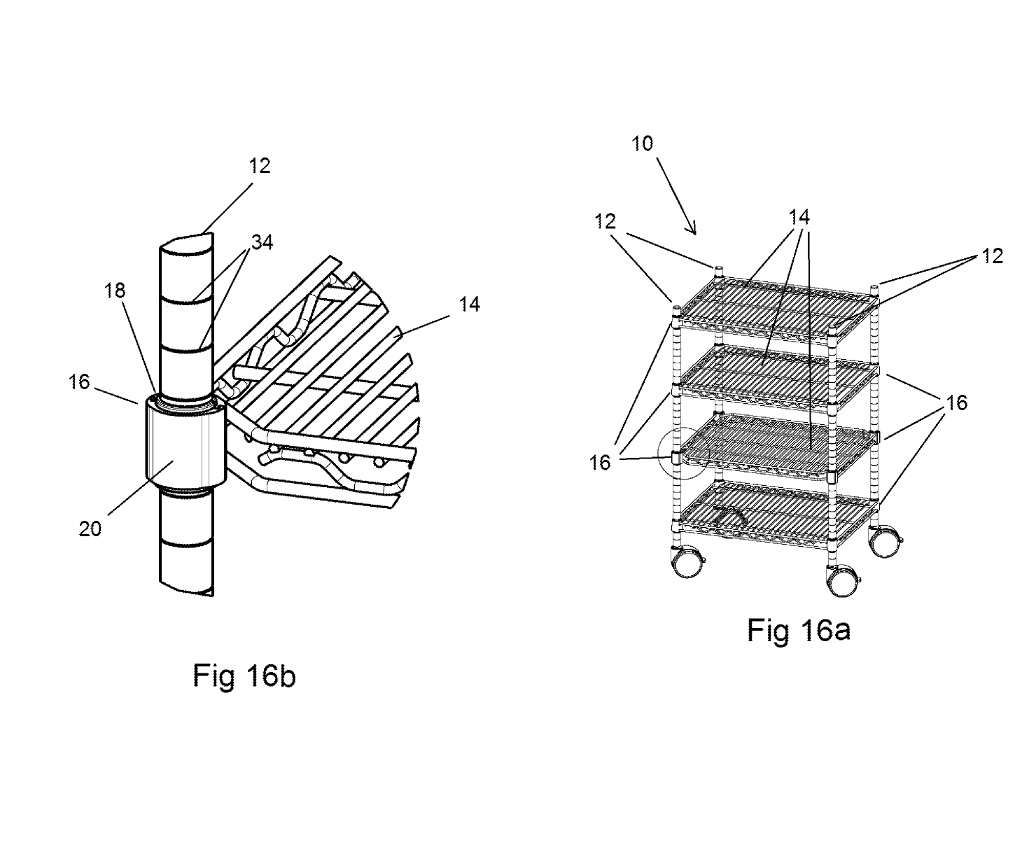

The second portion 20 of the bracket 14 is then placed above the first portion 18 (as shown in FIG. 14) and slid downwardly as shown in FIGS. 15 and 16 to engage with the first portion 18. The tapering thickness of the collar 22 results in increased engagement between the bracket 16 and the collar 22 as the second portion 20 of the bracket 16 moves into place. This engagement pushes the collar 22 inwardly such that the rib 32 engages into one of the grooves 34. Once in place, the collars 22 and therefore the brackets 16 and shelves 14 will be fixed in place relative to the posts 12.

The first and second portions 18 and 20 of the brackets 16 may also include an end stop (not shown) to prevent the lower end of the second portion 20 sliding below the lower end of the first portion 18. The first and second portions 18 and 20 may also be thicker adjacent the longitudinal edges thereof (as can be seen for example in FIG. 3b) to provide additional strength in these areas for connection.

As can be seen in FIGS. 1 to 8, the second portion 20 of the bracket 16 may be provided on the corner of an adjacent shelf 14. The bracket 16 is thereby formed by connecting the first and second bracket portions 18 and 20 of adjacent shelves 14 in adjacent frame structures.

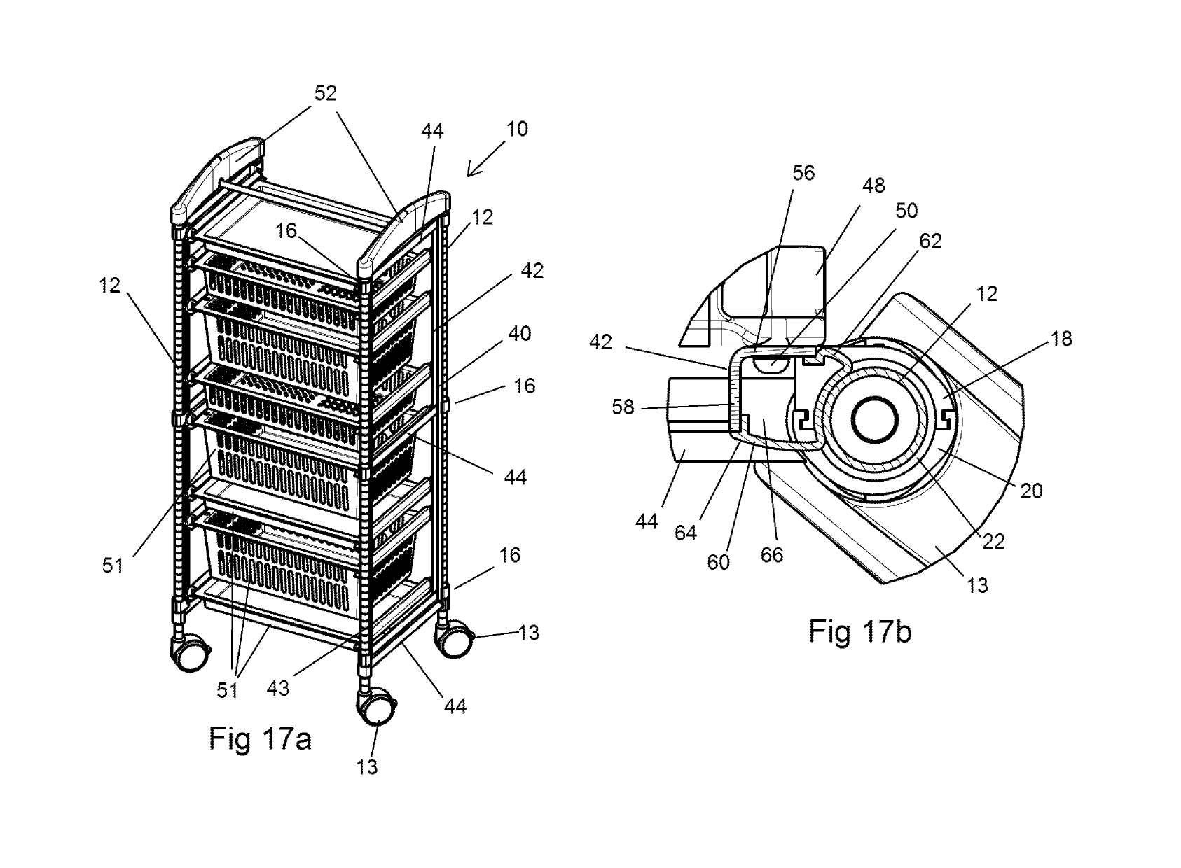

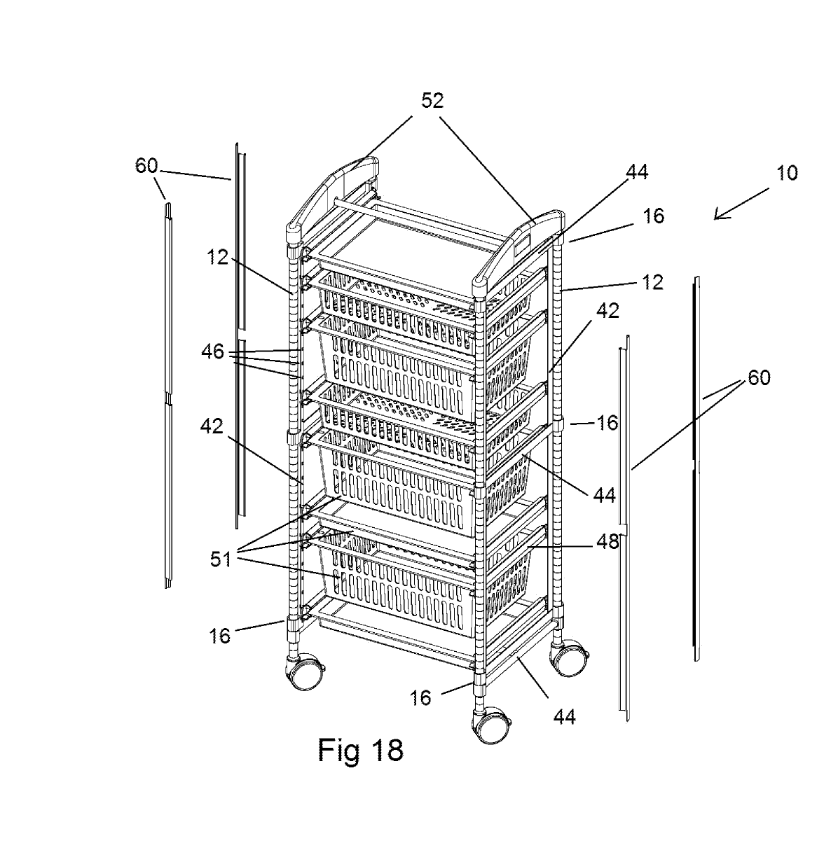

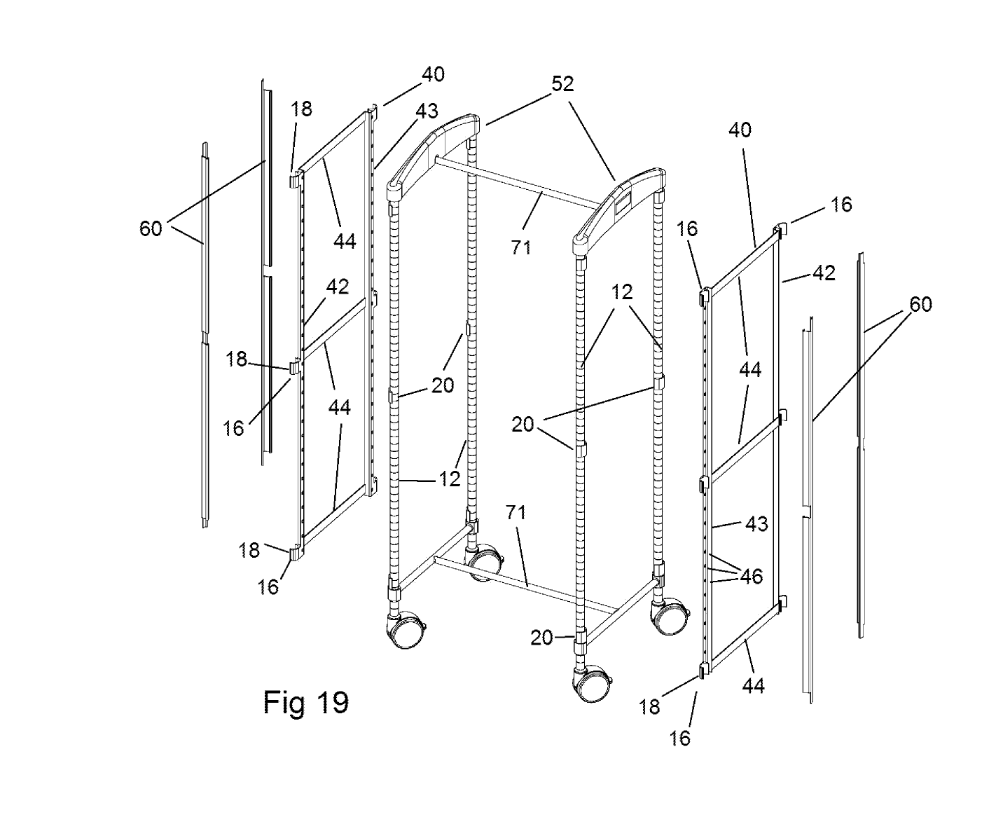

FIGS. 17 to 19 show a third embodiment of a shelving system 10 in accordance with the third aspect of the present invention. The shelving system 10 includes posts 12 of a construction similar to that of the previous embodiment. The shelving system 10 includes however side frames 40 which are connectable to the posts 12.

The side frames 40 comprise planar frames formed of first and second side members 42 and 43 and a plurality of cross members 44. In use, the side frames 40 are each securable to a pair of posts 12 such that a first of the posts 12 is located parallel and adjacent the first side member 42 and a second of the posts 12 is located adjacent and parallel to the second side member 43. The side frames 40 therefore extend across between a pair of adjacent posts 12. A first side frame 40 and connected posts 12 is secured to a second side frame 40 and connected posts 12 as shown in FIG. 17 to form a rectangular frame structure for storage.

The side frames 40 are provided with a plurality of brackets 16 of the same construction as the brackets 16 described previously. A plurality of collars 22 are also provided. The side frames 40 are therefore secured to the adjacent pair of posts 12 in the same manner as the shelves 14 of the previous embodiment.

Each of the side members 42 and 43 includes a plurality of apertures 46 along the lengths thereof. The apertures 46 are provided for connecting tracks 48 as described previously to support drawers 51.

The side members 42 and 43 of the side frames 40 each comprise an L-shaped extrusion, as can be seen in FIG. 17b. Each of the side members 42 and 43 therefor comprises a first planar portion 56 and a second planar portion 58 oriented perpendicular to the first planar portion 56. The first planar portion 56 includes the apertures 46 and is oriented parallel to the plane of the side member 40. The second planar portion 58 extends from an edge of the first planar portion 56 in a direction between the posts 12.

The side frames 40 are provided with cover strips 60 to connect across the longitudinal opening defined by the rear of the side members 42 and 43. Each of the cover strips 60 comprises a flexible extrusion having a first side 62 provided to engage with the distal edge of the first planar portion 56 and a second side 64 provided to engage with the distal edge of the second planar portion 58, as seen in FIG. 17b. The cover strips 60 extend between the side members 42 and 43 and the adjacent posts 12 and define an enclosed tubular chamber 66.

The cover strips 60 are removable from the side members 42 and 43. Therefore, in use, the cover strips 60 close off the rear of the side members 42 and 43 of the side frames 40. However, should any contaminants enter the tubular chamber 66 via the apertures 46, the cover strips 60 may be removed to allow cleaning.

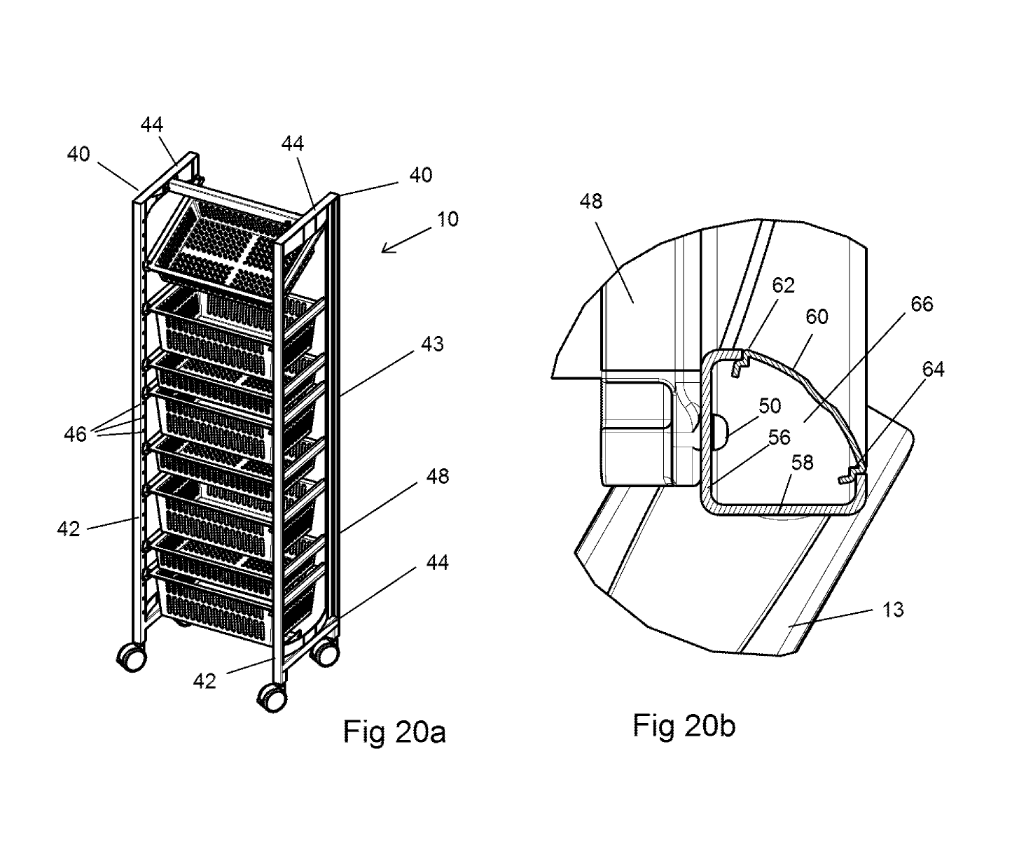

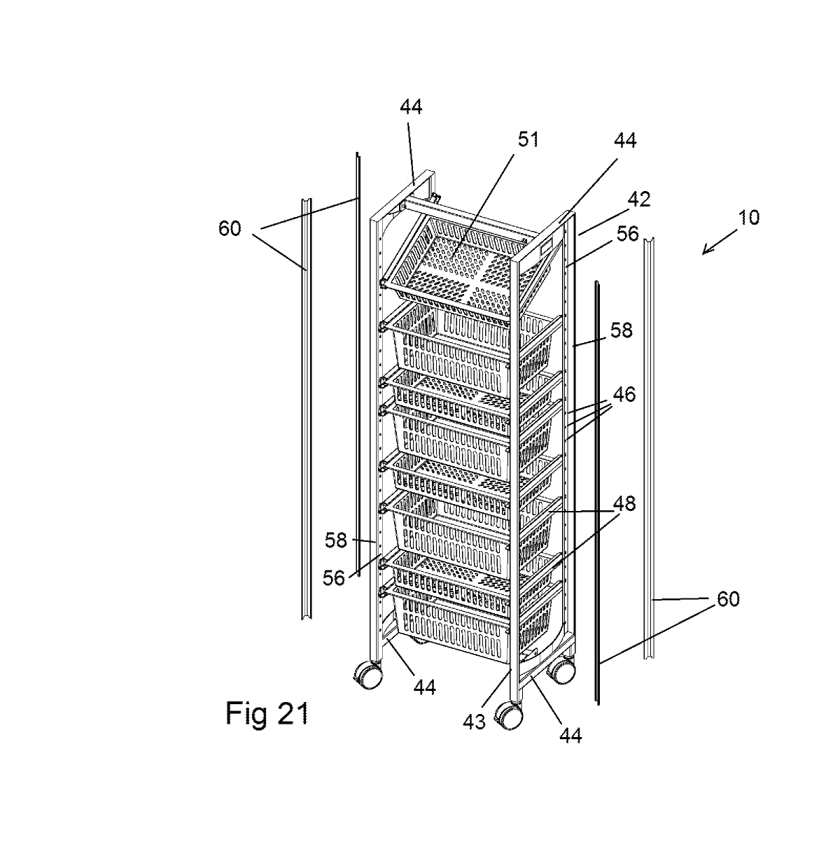

FIGS. 20 and 21 show a further embodiment of a shelving system in accordance with the third aspect of the present invention. The shelving system 10 is similar to that of FIGS. 17 to 19 and like reference numerals are used to denote like parts.

The shelving system 10 does not include posts 12 to which the side frames 40 are connected. A pair of side frames 40 are connected together to form the main structure of the shelving system 10 without the posts 12. The wheels 13 may therefore be provided on lower ends of the first and second side members 42 and 43.

The side members 42 and 43 are also L-shaped and include apertures 46 to receive lugs 50 of the tracks 48 in the same manner as the previous embodiment. The cover strip 60 is more planar in shape but still includes first and second sides 62 and 64 provided to engage with distal ends of the first and second planar portions 56 and 58 of the side members 42 and 43 to define the tubular chamber 66. The cover strips 60 are removable in order to allow cleaning, as described previously.

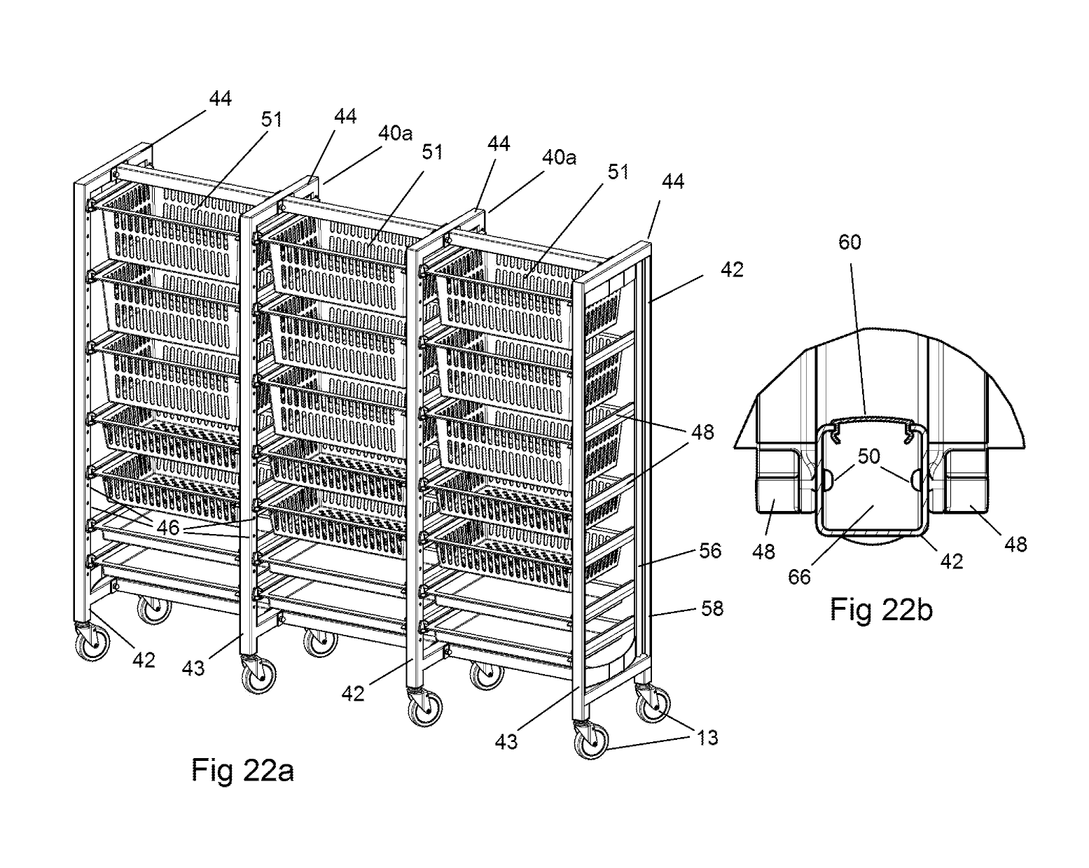

FIG. 22 shows a further embodiment of a shelving system 10 in accordance with the third aspect of the present invention. The embodiment of FIG. 22 is similar to the embodiment of FIGS. 20 and 21 and like reference numerals are used to denote like parts.

In the embodiment of FIG. 22, the system is provided for connecting multiple units together. The endmost frames 40 have the same construction as the frames 40 of FIGS. 20 and 21. The side members 42 and 43 of further frames 40a however are provided having a U-shaped cross section, as can be seen in FIG. 22b. This construction allows connection to tracks 48 on both sides of the frame 40a as can be seen. The cover strip 60 seals across the open end of the U-shaped side members 42 and 43 in the same manner as described previously.

It will be readily apparent to persons skilled in the relevant arts that various modifications and improvements may be made to the foregoing embodiments, in addition to those already described, without departing from the basic inventive concepts of the present invention.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. A shelving system comprising:
a plurality of tubular posts;
a plurality of rail segments securable parallel to the posts;
wherein each of the rail segments comprises an elongate member having a U-shaped cross section such that the rail segment includes a central wall and first and second side walls such that the posts are received between the first and second side walls and wherein the rail segments include apertures along the lengths thereof to receive tracks for supporting drawers.

26. The shelving system in accordance with claim 25, a plurality of brace members are provided connecting adjacent posts and the rail segments are supported between adjacent brace members.

27. The shelving system in accordance with claim 25, wherein the first and second side walls include end portions thereon having arcuate surfaces to engage with outer surfaces of the post.

28. The shelving system in accordance with claim 25, wherein the apertures are provided in the first and second side walls of the rail segments.

29. The shelving system in accordance with claim 26, wherein the rail segments include engaging portions adjacent ends thereof provided to engage with brace members such that each of the rail segments is secured between an adjacent pair of brace members.

30. The shelving system in accordance with claim 29, wherein the engaging portions comprise notches provided adjacent opposed ends of the rail segments.

31. The shelving system in accordance with claim 30, wherein each of the rail segments includes a pair of notches in each end thereof.

32. The shelving system in accordance with claim 25, wherein the brace members comprise elongate members extending between adjacent posts on a side of a frame structure formed by four posts, the brace members including brackets on ends thereof to receive the posts such that the brace members are supported from the post.

33. The shelving system in accordance with claim 32, wherein a plurality of cross braces are provided to extend between the posts on a first side of the frame structure and the posts on a second side of the frame structure.

34. The shelving system in accordance with claim 25, wherein one or more of the brace members comprises a side edge of a shelf supported within the frame structure.

35. A shelving system comprising:
a plurality of tubular posts;
a plurality of shelves;
a plurality of brackets provided on each of the shelves, each comprising a tubular member having a first portion secured to the shelves and a second portion securable to the first portion to define an opening between the first and the second portion; and
a plurality of collars receivable onto the corner posts;
wherein securing the second portion of each bracket to the first portion of the associated bracket such that a collar is located within the bracket secures the bracket relative to the post.

36. The shelving system in accordance with claim 35, wherein the first and second portions are each semi-cylindrical in shape such that when the second portion is secured to the first portion, the formed bracket is generally cylindrical in shape.

37. The shelving system in accordance with claim 36, wherein the posts each comprises a tubular member of circular cross section

38. The shelving system in accordance with claim 35, wherein each of the collars is formed of a first collar portion and a second collar portion wherein the first and second collar portions are each semi-cylindrical in shape and can be engaged with each other to form a cylindrical collar.

39. The shelving system in accordance with claim 38, wherein the first and second collar portions each include a recess on a first longitudinal side thereof and a protrusion on a second longitudinal side thereof such that the protrusions of the first and second collar portions are receivable in the recesses of the second and first collar portions respectively to form the cylindrical collar.

40. The shelving system in accordance with claim 35, wherein each of the collars includes a circular rib on an inner surface thereof provided to engage into one of a plurality of circular grooves provided along the length of each of the posts when the collar is compressed by the bracket.

41. The shelving system in accordance with claim 40, wherein the collars are tapered to be greater in thickness adjacent a lower end thereof such that as each of the brackets is engaged with the collar by sliding downwardly, the collars are compressed such that the rib engages into an adjacent groove, thereby securing the collar relative to the post.

42. The shelving system in accordance with claim 35, wherein the first and second portions of the brackets are engaged together by sliding.

43. The shelving system in accordance with claim 42, wherein the first portion of the bracket is provided with first engagement members along longitudinal edges thereof to engage with second engagement members provided along longitudinal edges of the second portion of the bracket.

44. The shelving system in accordance with claim 43, wherein each of the first and second engagement members comprises an elongate protrusion having a transverse lip portion adjacent a distal edge thereof defining a channel such that the lip portion of the second engagement member engages into the channel of the first engagement member and vice versa.

45. A shelving system comprising a plurality of side members each having apertures for receiving lugs of a storage unit component, wherein each of the side members includes a longitudinal opening coverable by a removable cover strip to define a tubular channel into which the lugs are located when received in the apertures.

46. The shelving system in accordance with claim 45, wherein each of the side frames includes an L-shaped extrusion having a first planar side portion and a second planar side portion such that the longitudinal opening is defined between distal edges of the first and second planar side portions.

47. The shelving system in accordance with claim 46, wherein the apertures are provided along the length of the first planar side portion.

48. The shelving system in accordance with claim 47, wherein the cover strip includes a first side provided to engage with the distal edge of the first planar side portion and a second side provided to engage with the distal edge of the second planar side portion.
